(19) United States
(12) Patent Application Publication
(10) Pub. No.: US 2006/0034226 A1
(43) Pub. Date: Feb. 16, 2006

(54) Radio resource control in HSUPA system

(76) Inventors: Jian Gu, Huangqi Nanhai Guangdong (CN); Xiangguang Che, Beijing (CN); Karri Ranta-Aho, Espoo (FI); Juho Pirskanen, Tampere (FI); Esa Malkamaki, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/966,146

(22) Filed: Oct. 18, 2004

(30) Foreign Application Priority Data
Aug. 16, 2004 (FI) 20045297

(51) Int. Cl. H04Q 7/00

(52) U.S. Cl. 370/332

(57) ABSTRACT

A radio resource control in an HSUPA system is provided. The control procedure includes: communicating data blocks between user equipment and a network infrastructure over a physical High Speed Uplink Packet Access channel; communicating block acknowledgement messages between the user equipment and the network infrastructure, each block acknowledgement message indicating whether or not a data block was received successfully; and controlling transmission power of the physical HSUPA channel on the basis of at least one block acknowledgement message.

### FIELD

The invention relates to a method of controlling radio resources in an HSUPA system, user equipment supporting an HSUPA protocol, a wireless telecommunications system supporting an HSUPA protocol, a network element, a computer program product encoding a computer program of instructions for executing a computer process for controlling radio resources in an HSUPA system, and a computer program distribution medium readable by a computer and encoding a computer program of instructions for executing a computer process for controlling radio resources in an HSUPA system.

### BACKGROUND

High Speed Uplink Packet Access (HSUPA) is a packet-based data service in a WCDMA (Wideband Code Division Multiple Access) downlink with typical data transmission capacity of a few megabits per second, thus enabling the use of symmetric high-speed data services, such as video conferencing, between user equipment and a network infrastructure.

An uplink data transfer mechanism in the HSUPA is provided by physical HSUPA channels, such as an E-DPDCH (Enhanced Dedicated Physical Data Channel), implemented on top of WCDMA uplink physical data channels such as a DPCCH (Dedicated Physical Control Channel) and a DPDCH (Dedicated Physical Data Channel), thus sharing radio resources, such as power resources, with the WCDMA uplink physical data channels. The sharing of the radio resources results in inflexibility in radio resource allocation to the physical HSUPA channels and the WCDMA physical data channels. Therefore, it is desired to consider improvements for radio resource control in an HSUPA system.

### BRIEF DESCRIPTION OF THE INVENTION

An object of the invention is to provide an improved method, user equipment, a wireless telecommunications system, a network element, a computer program product and a computer program distribution medium. According to a first aspect of the invention, there is provided a method of controlling radio resources in a High Speed Uplink Packet Access system, the method including: communicating data blocks between user equipment and a network infrastructure over a physical High Speed Uplink Packet Access channel; communicating block acknowledgement messages between the user equipment and the network infrastructure, each block acknowledgement message indicating whether or not a data block was received successfully; and controlling transmission power of the physical High Speed Uplink Packet Access channel on the basis of at least one block acknowledgement message.

According to a second aspect of the invention, there is provided user equipment supporting a High Speed Uplink Packet Access protocol, including: a transmitter for communicating data blocks between the user equipment and a network infrastructure over a physical High Speed Uplink Packet Access channel; a receiver for communicating block acknowledgement messages between the user equipment and the network infrastructure, each block acknowledgement message indicating whether or not a data block was received successfully; and a High Speed Uplink Packet Access channel power controller for controlling transmission power of the physical High Speed Uplink Packet Access channel on the basis of at least one block acknowledgement message.

According to a third aspect of the invention, there is provided user equipment supporting a High Speed Uplink Packet Access protocol, including: a first communicating means for communicating data blocks between the user equipment and a network infrastructure over a physical High Speed Uplink Packet Access channel; a second communicating means for communicating block acknowledgement messages, each block acknowledgement message indicating whether or not a data block was received successfully; and controlling means for controlling transmission power of the physical High Speed Uplink Packet Access channel on the basis of at least one block acknowledgement message.

According to a fourth aspect of the invention, there is a wireless telecommunications system supporting a High Speed Uplink Packet Access protocol, the wireless telecommunications system including a network infrastructure and user equipment comprising: a transmitter for communicating data blocks between the user equipment and the network infrastructure over a physical High Speed Uplink Packet Access channel; a receiver for communicating block acknowledgement messages between the user equipment and a network infrastructure, each block acknowledgement message indicating whether or not a data block was received successfully; and a High Speed Uplink Packet Access channel power controller for controlling transmission power of the physical High Speed Uplink Packet Access channel on the basis of at least one block acknowledgement message.

According to a fifth aspect of the invention, there is provided a wireless telecommunications system supporting a High Speed Uplink Packet Access protocol, the wireless telecommunications system comprising: a first communicating means for communicating data blocks between user equipment and a network infrastructure over a physical High Speed Uplink Packet Access channel; a second communicating means for communicating block acknowledgement messages between the user equipment and the network infrastructure, each block acknowledgement message indicating whether or not a data block was received successfully; and controlling means for controlling transmission power of the physical High Speed Uplink Packet Access channel on the basis of at least one block acknowledgement message.

According to a sixth aspect of the invention, there is provided a network element of a wireless telecommunications system supporting a High Speed Uplink Packet Access protocol, the network element comprising generating means for generating a reference value of a block reception quality measure, the reference value providing a value that is compared with a block reception quality measure generated from a plurality of the block acknowledgement messages in the user equipment, the block reception quality measure characterising the quality of reception of data blocks carried by a physical High Speed Uplink Packet Access channel, the transmission power of the physical High Speed Uplink Packet Access channel being controlled on the basis of a comparison between the reference value and the block reception quality measure; and the generating means is configured to signal the reference value of the block reception quality measure to the user equipment.

According to a seventh aspect of the invention, there is provided a computer program product encoding a computer program of instructions for executing a computer process for controlling radio resources in a High Speed Uplink Packet Access system, the process including: communicating data blocks between user equipment and a network infrastructure over a physical High Speed Uplink Packet Access channel; communicating block acknowledgement messages between the user equipment and the network infrastructure, each block acknowledgement message indicating whether or not a data block was received successfully; and controlling transmission power of the physical High Speed Uplink Packet Access channel on the basis of at least one block acknowledgement message.

According to yet another aspect of the invention there is provided a computer program distribution medium readable by a computer and encoding a computer program of instructions for executing a computer process for controlling radio resources in a High Speed Uplink Packet Access system, the process including: communicating data blocks between user equipment and a network infrastructure over a physical High Speed Uplink Packet Access channel; communicating block acknowledgement messages between the user equipment and the network infrastructure, each block acknowledgement message indicating whether or not a data block was received successfully; and controlling transmission power of the physical High Speed Uplink Packet Access channel on the basis of at least one block acknowledgement message.

As an advantage, the invention enables the separation of an overall power control and an HSUPA power control, thus enabling a separate power adjustment mechanism for the physical HSUPA channels and the physical channels carrying the physical HSUPA channels. The separate power adjustment mechanisms increase the flexibility of the power control and thus allow the use of optimum transmission power for the physical HSUPA channels and the physical channels carrying the physical HSUPA channels simultaneously.

### LIST OF DRAWINGS

In the following, the invention will be described in greater detail with reference to the embodiments and the accompanying drawings, in which

FIG. 1 shows a first example of a wireless telecommunications system;

FIG. 2 shows an example of an HSUPA channel structure and an HSUPA protocol;

FIG. 3 shows a second example of a wireless telecommunications system;

FIG. 4 shows another example of a wireless telecommunications system;

FIG. 5 illustrates a first example of a methodology according to embodiments of the invention;

FIG. 6 illustrates a second example of a methodology according to embodiments of the invention, and

FIG. 7 illustrates another example of a methodology according to embodiments of the invention.

### DESCRIPTION OF EMBODIMENTS

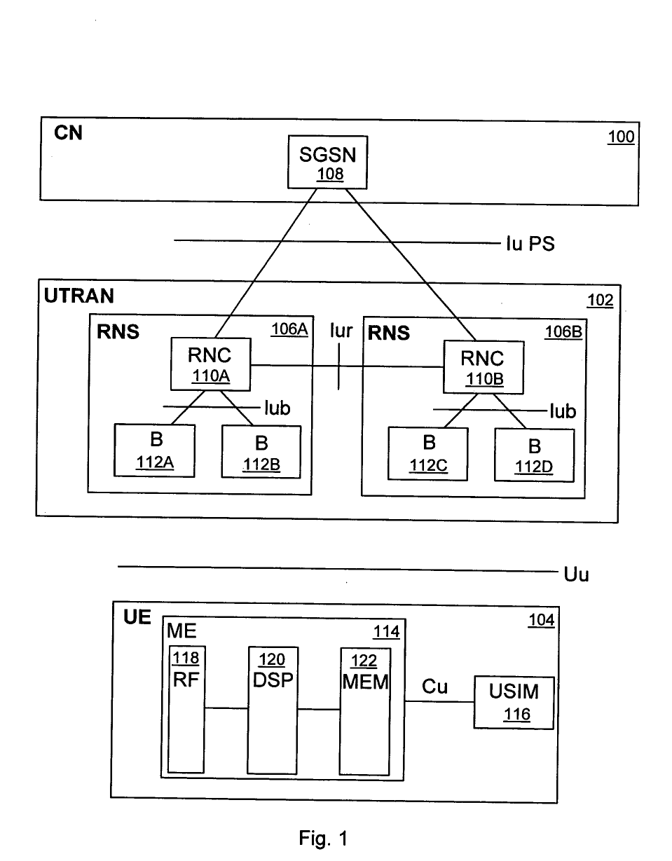

FIG. 1 illustrates an example of a wireless telecommunications system to which the present solution may be applied. Below, embodiments of the invention will be described using the UMTS (Universal Mobile Telecommunications System) as an example of the wireless telecommunications system. The invention may, however, be applied to any wireless telecommunications system that supports HSUPA protocol elements, such as HARQ (Hybrid Automatic Retransmission Request) and AMC (Adaptive Modulation and Coding). The structure and the functions of such a wireless telecommunications system and those of the associated network elements are only described when relevant to the invention.

The wireless telecommunications system may be divided into a core network (CN) 100, a UMTS terrestrial radio access network (UTRAN) 102, and user equipment (UE) 104. The core network 100 and the UTRAN 102 compose a network infrastructure of the wireless telecommunications system.

The UTRAN 102 is typically implemented with wideband code division multiple access (WCDMA) radio access technology.

The core network 100 includes a serving GPRS support node (SGSN) 108 connected to the UTRAN 102 over an Iu PS interface. The SGSN 108 represents the center point of the packet-switched domain of the core network 100. The main task of the SGSN 108 is to transmit packets to the user equipment 104 and to receive packets from the user equipment 104 by using the UTRAN 102. The SGSN 108 may contain subscriber and location information related to the user equipment 104.

The UTRAN 102 includes radio network sub-systems (RNS) 106A, 106B, each of which includes at least one radio network controller (RNC) 110A, 110B and nodes B 112A, 112B, 112C, 112D.

Some functions of the radio network controller 110A, 110B may be implemented with a digital signal processor, memory, and computer programs for executing computer processes. The basic structure and the operation of the radio network controller 110A, 110B are known to one skilled in the art and only the details relevant to the present solution are discussed in detail.

The node B 112A, 112B, 112C, 112D implements the Uu interface, through which the user equipment 104 may access the network infrastructure.

Some functions of the base station 112A, 112B, 112C, 112D may be implemented with a digital signal processor, memory, and computer programs for executing computer processes.

The basic structure and operation of the base station 112A, 112B, 112C, 112D are known to one skilled in the art and only the details relevant to the present solution are discussed in detail.

The user equipment 104 may include two parts: mobile equipment (ME) 114 and a UMTS subscriber identity module (USIM) 116.

The mobile equipment 114 typically includes radio frequency parts (RF) 118 for providing the Uu interface.

The user equipment 104 further includes a digital signal processor 120, memory 122, and computer programs for executing computer processes. The user equipment 104 may further comprise an antenna, a user interface, and a battery not shown in FIG. 1.

The USIM 116 comprises user-related information and information related to information security in particular, for instance an encryption algorithm.

The basic structure and operation of the user equipment 104 are known to one skilled in the art and only the details relevant to the present solution are discussed in detail.

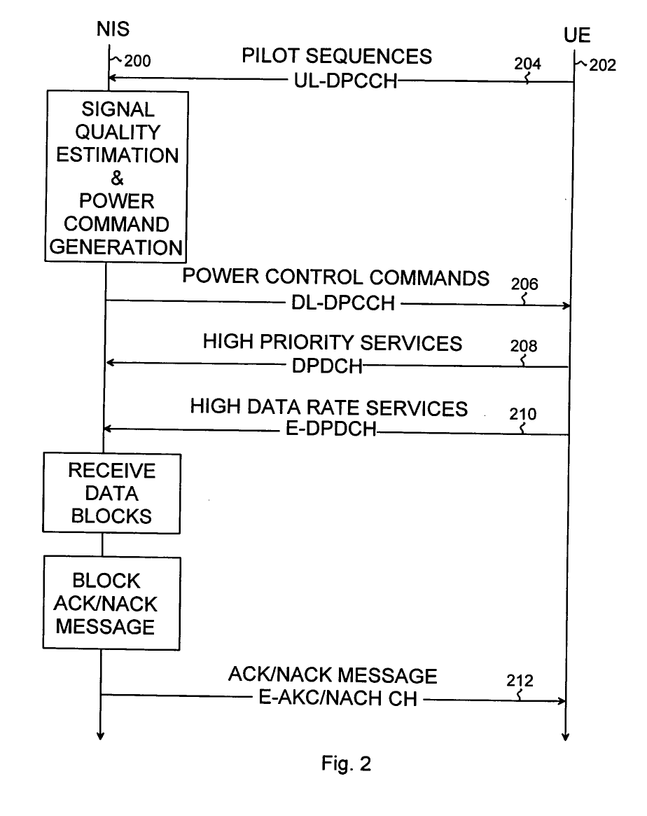

FIG. 2 illustrates an example of physical channels and procedures associated with the HSUPA protocol. The network infrastructure (NIS) is presented by vertical axis 200 and the user equipment is presented by vertical axis 202.

An uplink control channel, such as an uplink DPCCH (Dedicated Physical Control Channel) defined in the 3GPP (3^{rd} Generation Partnership Project) specification, transmitted by the user equipment 200 includes pilot sequences. The network infrastructure 200 encodes the pilot sequences and estimates signal quality parameters, such as SIR (Signal-to-Interference Ratio), of the uplink DPCCH 204.

The network infrastructure 200 generates power control commands on the basis of the signal quality parameters and transmits the power control commands to the user equipment 202 over a downlink control channel 206, such as a downlink DPCCH. The power control commands may be associated with an inner loop of a closed-loop power control protocol, for example.

The user equipment 202 may be connected to the network infrastructure 200 over an uplink physical data channel 208, such as a DPDCH (Dedicated Physical Data channel) defined in the 3GPP specification. The uplink physical data channel 208 represents a conventional data channel that as such excludes the use of the HSUPA protocol. The uplink physical data channel 208 is typically used for high priority services, such as conversational class speech services and RRC (Radio Resource Signalling), in relation to the HSUPA data transfer capacity.

High data rate packet services in the uplink are provided by a physical HSUPA channel 210, such as an E-DPDCH (Enhanced Dedicated Physical Data Channel) defined in the 3GPP specification. The E-DPDCH transfers data blocks in predetermined temporal intervals, such as a TTI (Transmission Time Interval). Each data block is received, and a CRC (Cyclic Redundancy Check) procedure, for example, is used to test the success of the reception of the block.

A block acknowledgement message is generated for each data block on the basis of the test. If the data block was received successfully, the block acknowledgement message indicates “acknowledgement (ACK)”. If the data block was received unsuccessfully, the block acknowledgement message indicates “non-acknowledgement (NACK)”.

The block acknowledgement message is transmitted from the infrastructure 200 over an HSUPA acknowledgement message channel 212.

The uplink physical data channel 208 and the physical HSUPA channel 210 are parallel code channels each typically having different channel codes.

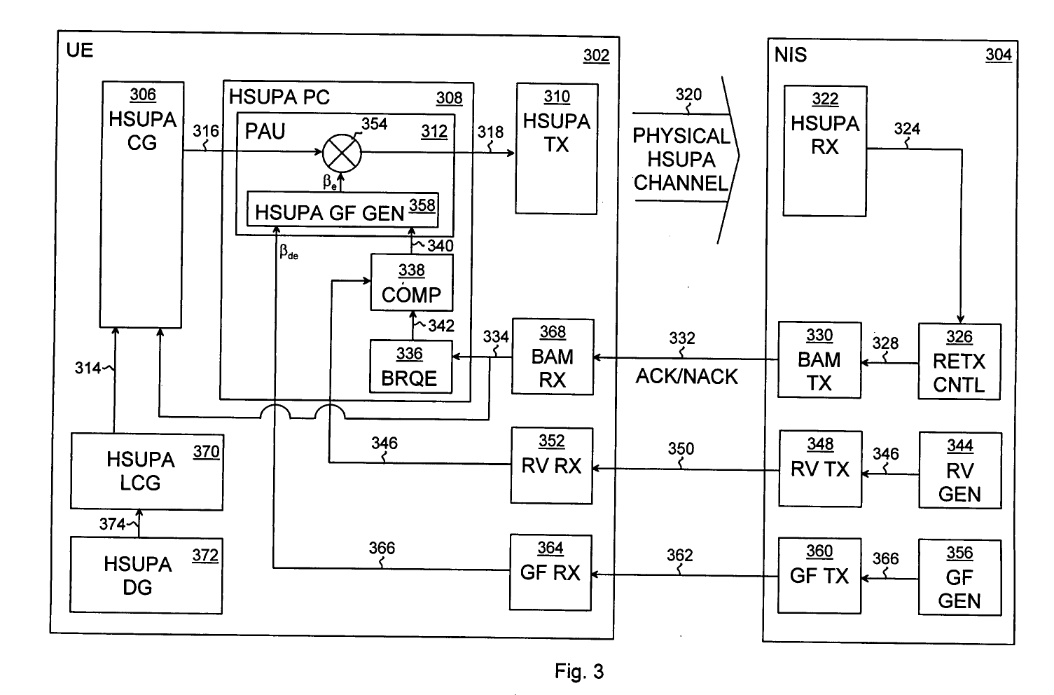

With reference to FIG. 3, the user equipment 302 supporting the HSUPA protocol includes an HSUPA channel generator (HSUPA CG) 306 that generates the physical HSUPA channel 316 from an HSUPA logical channel 314, such as an E-DCH (Enhanced Dedicated Channel).

The HSUPA logical channels 314 may be generated in an HSUPA logical channel generator 370 from an HSUPA data flow 374 received from an HSUPA data generator (HSUPA DG) 372.

The physical HSUPA channel 316 is inputted into an HSUPA power controller 308. The HSUPA power controller 308 may include a power adjustment unit (PAU) 312 for adjusting the signal power of the physical HSUPA channel 316. The power adjustment unit 312 typically operates in a digital domain and directs power adjustment to a digital signal carrying the physical HSUPA channel 316. The power adjustment unit 312 may be implemented with a digital multiplier 354 that multiplies the digital signal carrying the physical HSUPA channel 316 by a multiplication factor, such as an HSUPA gain factor βₑ.

The power adjustment unit 312 may include an HSUPA gain factor generator (HSUPA GF GEN) 358 connected to the digital multiplier 354 that implements the use of the HSUPA gain factor.

In an embodiment of the invention, the HSUPA power controller 308 controls the transmission power of the physical HSUPA channel in relation to the transmission power of an uplink physical data channel carrying the physical HSUPA channel.

The HSUPA gain factor is typically a coefficient that contributes exclusively to the transmission power of the physical HSUPA channels, such as the E-DPDCH, and it is directly independent of an overall fast closed-loop power control of all the uplink physical channels, including the physical HSUPA channels. In this context, the overall power control is based on power control commands received from the network infrastructure 304 and it contributes to a set of parallel code channels including the physical HSUPA channels. Especially, the HSUPA gain factor typically leaves the transmission power of other uplink physical channels, such as the DPDCH, not carrying the physical HSUPA channels, unaltered.

The power adjustment unit 312 inputs the physical HSUPA channel 318 into an HSUPA transmitter (HSUPA TX) 310 that communicates the data blocks between the user equipment 302 and the network infrastructure 304 over the physical HSUPA channel 320. The HSUPA transmitter 310 typically converts a digital format physical HSUPA channel 318 into radio frequency and transmits the physical HSUPA channel 320 over a radio interface, such as the Uu interface.

An HSUPA receiver (HSUPA RX) 322 located in the network infrastructure 304 receives the physical HSUPA channel 320 transmitted over the radio interface. The HSUPA receiver 322 encodes the data blocks transmitted over the physical HSUPA channel 320 and provides an encoding report 324 to a retransmission controller (RETX CNTL) 326. The encoding report 324 typically includes results of the success of the encoding of each data block.

The retransmission controller 326 receives the encoding report 324 and implements parts of a HARQ protocol. The retransmission controller 326 generates a block acknowledgement message 328 for each data block. The acknowledgement message 328 is inputted into a block acknowledgement message transmitter (BAMTX) 330 that transmits the block acknowledgement message 332 to the user equipment 302 over the radio interface.

The user equipment 302 includes a block acknowledgement message receiver (BAMRX) 368 for communicating the block acknowledgement message 332 between the user equipment 302 and the network infrastructure 304.

The block acknowledgement message receiver 368 receives the block acknowledgement message 332 and inputs the block acknowledgement message 334 into the HSUPA channel generator 306. The HSUPA channel generator 306 may carry out a retransmission procedure according to the HARQ protocol on the basis of the block acknowledgement message 334.

In an embodiment of the invention, the HSUPA power controller 308 includes a block reception quality estimator (BRQE) 336 for generating a block reception quality measure 342 from a plurality of block acknowledgement messages 334.

The block reception quality measure 342 is typically a statistical quantity characterising the quality of reception of data blocks associated with the block acknowledgement messages 334. The block reception quality measure 342 typically includes long-term quality information on the physical HSUPA channel 320.

In an embodiment of the invention, the block reception quality measure is proportional to HSUPA BLER (Block Error Ratio), herein denoted BLER, that represents the ratio of the number of unsuccessfully received blocks to the total number of blocks transferred by the physical HSUPA channel 320.

The block reception quality measure 342 may further define an average retransmission rate per data block.

In an embodiment of the invention, the HSUPA power controller 308 includes a comparator (COMP) 338 connected to the block reception quality estimator 336. The block reception quality estimator 336 inputs the block reception quality measure 342 into the comparator 338 which performs a comparison between the block reception quality measure 342 and a reference value of the block reception quality measure.

The comparator 338 inputs a comparison result 340 into the HSUPA gain factor generator 358 which generates the HSUPA gain factor according to the comparison.

Let us suppose the block reception quality measure 342 is BLER and the reference value of the block reception quality measure is target BLER, here denoted BLER_{target}. The invention is not restricted to the use of BLER parameters, and one skilled in the art is capable of extending the use of the block reception quality measure 342 and a reference value of the block reception quality measure to other cases by using the teachings of the given example.

A BLER less than BLER_{target} may indicate that the transmission power of the physical HSUPA channel 320 is above an optimum power and thus the power adjustment unit 312 decreases the transmission power by decreasing the value of the HSUPA gain factor.

A BLER greater than BLER_{target} may indicate that the transmission power of the physical HSUPA channel 320 is below an optimum power and thus the power adjustment unit 312 increases the transmission power by increasing the value of the HSUPA gain factor.

In an embodiment of the invention, the network infrastructure 304 includes a reference value generator (RV GEN) 344 for generating the reference value 346 of the block reception quality measure and for signalling the reference value 346 to the user equipment 302. The reference value 346 may be defined by a network operator operating the wireless telecommunications system. The reference value 346 may be contributed by service characteristics of a service provided by the HSUPA protocol. Such service characteristics may include, for example, retransmission delay between data blocks and/or the maximum transmission data rate supported by the user equipment 302. In some embodiments, the RNC 110A, 110B periodically optimises and updates the reference value 346 according to the current state of the wireless telecommunications system.

The reference value generator 344 inputs the reference value 346 into a reference value transmitter 348 (RV TX), which transmits a signal 350 carrying the reference value 346 over the radio interface. The reference value 346 may be signalled by using a higher layer signalling.

The user equipment 302 may include a reference value receiver (RV RX) 352 that receives the signal 350 carrying the reference value 346 and inputs the reference value 346 into the comparator 338.

In an embodiment of the invention, the HSUPA gain factor is a superposition of a block reception quality independent gain factor, here denoted β_{de}, and a block reception quality dependent gain factor, here denoted Δₑ. In this case, the HSUPA gain factor βₑ may be written as
βₑ=β_{de}+Δₑ. (1)

The block reception quality independent gain factor β_{de} is independent of the block acknowledgement messages and thus the encoding result of the data blocks carried by the physical HSUPA channel 320.

The block reception quality dependent gain factor βₑ represents a block acknowledgement message dependent part of the HSUPA gain factor βₑ, thus characterizing the quality of reception of the data blocks carried by the physical HSU PA channel 320.

The block reception quality independent gain factor β_{de} may be proportional to an overall transmission power level concerning the set of parallel code channels and determined by channel estimation, for example.

In an embodiment of the invention, the HSUPA gain factor generator 358 receives the comparison result 340 of BLER and BLER_{target}, for example, and sets the value of the block reception quality dependent gain factor Δₑ according to the comparison result 340. The HSUPA gain factor generator 358 may calculate the HSUPA gain factor βₑ according to Equation (1) and input the HSUPA gain factor βₑ into the multiplier 354.

In an embodiment of the invention, the HSUPA power controller 312 controls the transmission power of the physical HSUPA channel 320 by taking into account a transport format applied to data blocks to be communicated over the physical HSUPA channel 320. The HSUPA gain factor generator 358 may include a table of block reception quality dependent gain factors Δₑ for candidate transport formats for different values of the comparison result 340. A block reception quality dependent gain factor Δₑ corresponding to an applied transport format is selected and substituted to Equation (1), for example. A transport format sensitive the power control also accounts for the applied data transfer rate and thus improves the efficiency of the use of radio resources.

The block reception quality independent gain factor β_{de} is typically determined in the network infrastructure 304. In an embodiment of the invention, the network infrastructure 304 includes a gain factor generator (GF GEN) 356 for generating the block reception quality independent gain factor 366. The gain factor generator 356 may be connected to a closed-loop power control system that provides an inner loop power control command for the gain factor generator 356. The gain factor generator 356 may apply an appropriate scaling to the block reception quality independent gain factor β_{de}.

The block reception quality independent gain factor 366 is inputted into a gain factor transmitter 360. The gain factor transmitter 360 transmits a signal 362 carrying the block reception quality independent gain factor 366 over the radio interface.

The user equipment 302 may include a gain factor receiver (GF RX) 364 for receiving the signal carrying 362 the block reception quality independent gain factor 366. The gain factor receiver 364 inputs the block reception quality independent gain factor 366 into the HSUPA gain factor generator 358.

In an embodiment of the invention, the block reception quality independent gain factor 366 is generated in the HSUPA gain factor generator 358 or in another functional block of the user equipment 302. The user equipment 302 may generate the block reception quality independent gain factor 366 on the basis of overall power control commands signalled by the RNC 110A, 110B, for example.

The HSUPA power controller 308 may be implemented with computer programs stored in the memory 122 and executed in the digital signal processor 120 of the user equipment 104. In some applications, ASICs (Application Specific Integrated Circuits) and/or FPGAs (Field Programmable Gate Arrays) may be applied.

The block acknowledgement message transmitter 330, the reference value transmitter 348, and the gain factor transmitter 360 may be implemented by using a base station transmitter located in a node B 112A, 112B, 112C, 112D.

The gain factor generator 356 and the reference value generator 344 may be located in the RNC 110A, 110B and implemented with the digital signal processor and software of the RNC 110A, 110B.

The block acknowledgement message receiver 368, the reference value receiver 352 and the gain factor receiver 364 may be implemented in the radio frequency parts 118 of the user equipment 104.

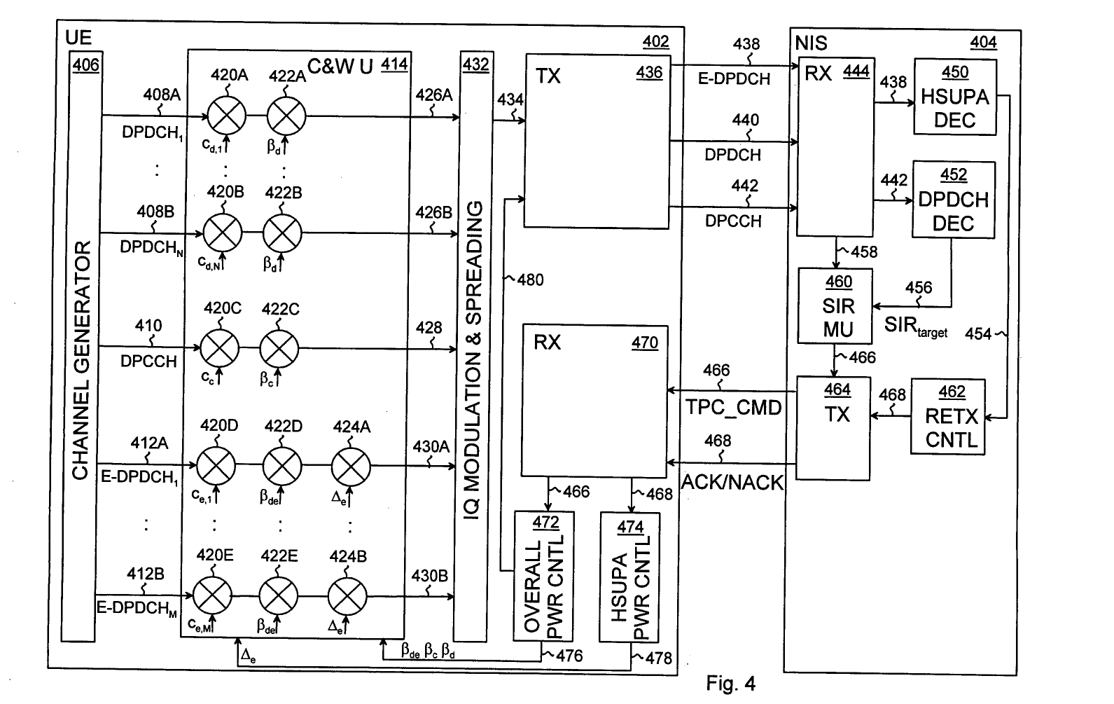

With reference to FIG. 4, the parallel code channels, i.e. the DPDCH channels 408A, 408B, the DPCCH channel 410, and the E-DPDCH channels 412A, 412B are generated in a channel generator 406 of the user equipment 402.

The number of DPDCH channels 408A, 408B is denoted N, where N=0, 1, 2, 3, 4, 5, for example.

The number of E-DPDCH channels 412A, 412B is denoted M, where 1<M<6, for example.

The parallel code channels 408A to 412 B are inputted into a coding and weighting unit (C&W U) 414 responsible to channel coding and power adjustment of the parallel code channel 408A to 412B.

The coding and weighting unit 414 includes DPDCH code multipliers 420A, 420B that multiply the DPDCH channels 408A, 408B by DPDCH channel code coefficients c_{d,1},c_{d,N}.

The coding and weighting unit 414 includes DPDCH weight multipliers 422A, 422B that multiply the DPDCH channels 408A, 408B by a DPDCH gain factor β_{d}.

Coded and weighted DPDCH channels 426A, 426B are inputted into an IQ modulation and spreading unit 432.

The coding and weighting unit 414 includes a DPCCH code multiplier 420C that multiplies the DPCCH channel 410 by a channel code coefficient c_{c}.

The coding and weighting unit 414 includes a DPCCH weight multiplier 422C that multiplies the DPCCH channel 410 by a DPCCH gain factor β_{c}.

A coded and weighted DPCCH channel 428 is inputted into the IQ modulation and spreading unit 432.

The coding and weighting unit 414 includes E-DPDCH code multipliers 420D, 420E that multiply the E-DPDCH channels 412A, 412B by E-DPDCH channel code coefficients c_{e,1}, c_{e,M}.

The coding and weighting unit 414 includes first E-DPDCH weight multipliers 422D, 422E that multiply the E-DPDCH channels 412A, 412B by a block reception quality independent gain factor β_{de}.

The coding and weighting unit 414 includes second E-DPDCH weight multipliers 424A, 424B that multiply the E-DPDCH channels 412A, 412B by a block reception quality dependent gain factor Δₑ.

Coded and weighted E-DPDCH channels 430A, 430B are inputted into the IQ modulation and spreading unit 432.

For clarity of illustration, the I and Q branches of signal paths are not shown. The IQ modulation and spreading unit 432 typically adds up the physical channels 426A to 430B, IQ modulates combined signals and applies spreading coding to the combined signals.

A combined signal 434 including the physical channels 408A to 412B is inputted into a transmitter 436.

The transmitter 436 transmits the E-DPDCH channels 438, the DPDCH channels 440, and the DPCCH channel 442 to the network infrastructure 404 over the radio interface.

A receiver 444 of the network infrastructure 404 receives the E-DPDCH channels 438, DPDCH channels 440 and the DPCCH channel 442. The receiver 444 is typically a part of base station transceiver located in one of the nodes B 112A to 112B.

In an embodiment of the invention, the network infrastructure 404 includes an HSUPA decoder 450 connected to the receiver 444. The HSUPA decoder decodes the data blocks carried by the E-DPDCH channels 438 and generates the encoding report 454. The encoding report 454 is delivered to the retransmission controller 462.

The retransmission controller 462 generates the block acknowledgement messages 468 and inputs the block acknowledgement messages 468 into a transmitter 464.

The transmitter transmits the block acknowledgement messages 468 to the user equipment 402 over the radio interface.

The DPDCH channels 442 are inputted into a DPDCH decoder 454 responsible for decoding data blocks delivered by the DPDCH channels 440. The DPDCH decoder 452 may calculate BLER for a plurality of data blocks delivered by the DPDCH channels 440 and compare BLER with a target value. A target SIR 456 is generated on the basis of the comparison, and the target SIR 456 is inputted into a SIR measurement unit (SIR MU) 460. The SIR measurement unit 460 measures SIR from the pilot sequences of the DPCCH channel 458 obtained from the receiver 444. Quality metrics calculated from the plurality of data blocks delivered by the E-DPDCH channels 438 may also be used in generating the target SIR 456.

A measured SIR is compared with the target SIR 456 and a series of power control commands (TPC_CMD) 466 are generated so that the measured SIR converges to the target SIR 456.

The power control commands 466 are inputted into the transmitter 464 and transmitted to the user equipment 402 over the radio interface.

A receiver 470 in the user equipment 402 receives the block acknowledgement messages (ACK/NACK) 468 and the power control commands (TCP_CMD) 466.

The power control commands 466 are inputted into an overall power controller (OVERALL PWR CNTL) 472 of the user equipment 402. The overall power controller 472 interprets the power control commands 466 and generates the block reception quality independent gain factor β_{de}, the DPDCH gain factor β_{d}, and the DPCCH gain factor β_{c} according to the power control commands 466.

The form of the gain factors β_{c}, β_{d} and β_{de} may vary depending on the embodiment. In some embodiments, the gain factors β_{c}, β_{d} and β_{de} are composed of a rapidly varying term proportional to the power control command 466 and a semi-static term that depends on the information delivered to the user equipment 402 by the network infrastructure 404 with higher layer signalling. In some other embodiments, the gain factors β_{c}, β_{d} and β_{de} are composed only of these semi-static elements and the rapidly varying term is superimposed to all the channels in the IQ modulation & spreading unit 432 or transmitter unit 436. The basic functionality of the gain factors β_{c}, β_{d} and β_{de} is to set the power proportions of different physical channels DPCCH, DPDCH, E-DPDCH, and the rapidly varying component derived from the power control commands 466 adjusts the actual transmitted power without affecting the power proportion of different channels. However, the detailed structure of the gain factors β_{c}, β_{d} and β_{de} does not restrict the embodiments of the invention.

Furthermore, a superposition of gain factors affecting the same signal path may be implemented in various ways. The gain factors may apply separate multipliers 422A to 424B or the superposition of the gain factors may be formed in the controllers 472, 474.

The block reception quality independent gain factor β_{de}, the DPDCH gain factor β_{d}, and the DPCCH gain factor β_{c} are inputted into the coding and weighting unit 414 by using a control signal 476. The block reception quality independent gain factor β_{de}, the DPDCH gain factor β_{d}, and the DPCCH gain factor β_{c} affect the power proportion of the E-DPDCH 438 channels when compared to other physical channels, such as the DPCCH 442 and DPDCH 440. The HSUPA power controller 474 receives the block acknowledgement messages 468 and generates the block reception quality dependent gain factor Δₑ by using the comparison between the USDPA BLER obtained from a plurality of block acknowledgement messages 468 and the BLER_{target}, for example.

A control signal 478 carrying the block reception quality dependent gain factor Δₑ is inputted into the coding and weighting unit 414.

The overall power controller 472 typically manages the power control associated with the closed-loop power control provided by the DPDCH decoder 452 and the SIR measurement unit 460. The overall power controller 472 may further supply power control commands 480 to the transmitter 436. The transmitter 436 may perform an analogue adjustment of the transmission amplifiers accordingly.

The HSUPA power controller manages the transmission power of the E-DPDCH channels 438. The separation of the overall power control and the HSUPA power control allows the physical HSUPA channel 438 to be controlled in relation to the transmission power of an uplink physical data channel carrying the physical HSUPA channel 438, thus enabling a separate power adjustment mechanism for the E-DPDCH channels 438 and the DPDCH channels. The separate power adjustment mechanisms increase the flexibility of the power control and thus allow the use of optimum transmission power for the E-DPDCH channels 438 and the DPDCH channels 440 simultaneously.

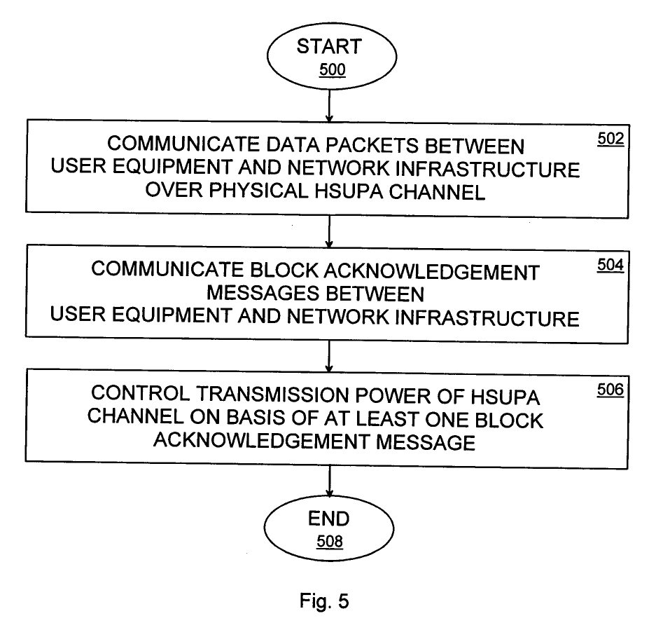

With reference to FIGS. 5, 6 and 7, examples of methodology according to embodiments of the invention are shown in flow charts.

In FIG. 5, the method starts in 500.

In 502, data blocks are communicated between the user equipment 302 and the network infrastructure 304 over the physical HSUPA channel 320.

In 504, block acknowledgement messages 328 are communicated between the user equipment 302 and the network infrastructure 304, each block acknowledgement message 328 indicating whether or not a data block was received successfully.

In 506, the transmission power of the physical HSUPA channel 320 is controlled on the basis of at least one block acknowledgement message 328.

In an embodiment of the invention, the transmission power of the physical HSUPA channel 320 is controlled by taking into account a transport format applied to data blocks to be communicated over the physical HSUPA channel 320.

In an embodiment of the invention, the transmission power of the physical HSUPA channel 320 is controlled in relation to the transmission power of an uplink physical data channel carrying the physical HSUPA channel 320.

In 508, the method ends.

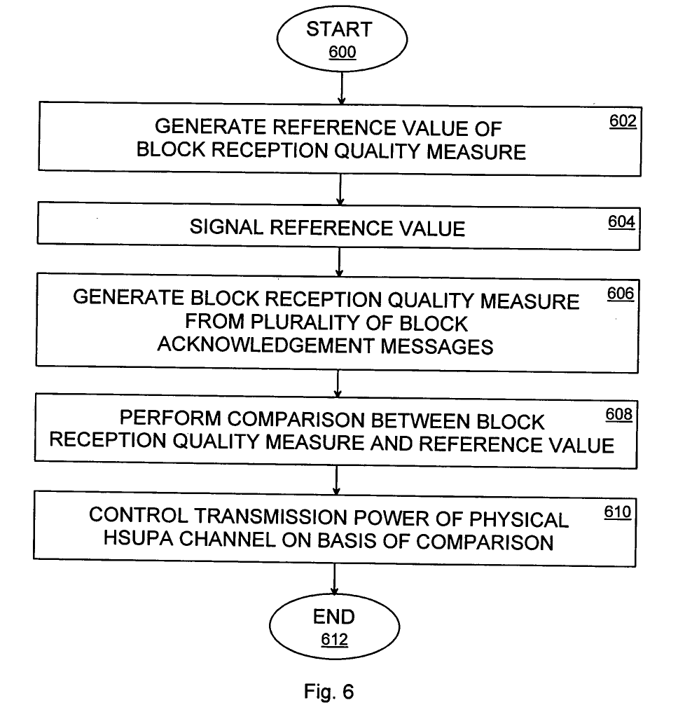

In FIG. 6, the method starts in 600.

In 602, the reference value 346 of the block reception quality measure is generated.

In 604, the reference value 346 of the block reception quality measure is signalled.

In 606 a block reception quality measure 342 is generated from a plurality of block acknowledgement messages 334, the block reception quality measure 342 characterising a quality of reception of data blocks associated with the block acknowledgement messages 334.

In 608, a comparison between the block reception quality measure 342 and the reference value 346 of the block reception quality measure is performed.

In 610, the transmission power of the physical HSUPA channel 320 is controlled on the basis of the comparison.

In 612, the method ends.

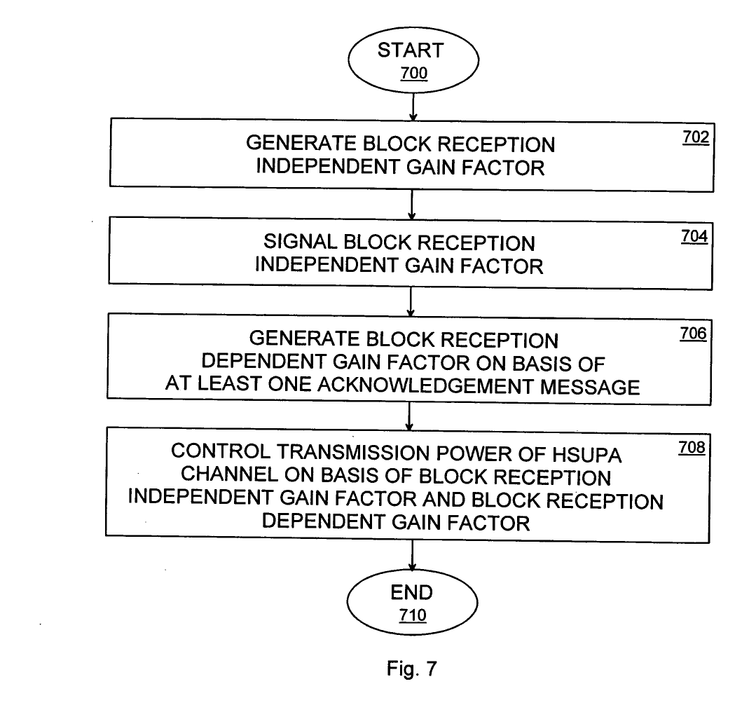

In FIG. 7, the method starts in 700.

In 702, a block reception quality independent gain factor 366 is generated.

In 704, the block reception quality independent gain factor 366 is signalled.

In 706, a block reception quality dependent gain factor is generated on the basis of the at least one block acknowledgement message 334.

In 708, the transmission power of the physical HSUPA channel 320 is controlled by using the block reception quality independent gain factor 366 and the block reception quality dependent gain factor.

In 710, the method ends.

In an aspect, the invention provides a computer program product encoding a computer program of instructions for executing a computer process.

In another aspect, the invention provides a computer program distribution medium readable by a computer and encoding a computer program of instructions for executing a computer process.

The distribution medium may include a computer readable medium, a program storage medium, a record medium, a computer readable memory, a computer readable software distribution package, a computer readable signal, a computer readable telecommunications signal, and/or a computer readable compressed software package.

Embodiments of the computer process are shown and described in conjunction with FIGS. 5, 6 and 7.

The computer program may be executed in the digital signal processor 120 of the user equipment 104. Some process steps may be executed in the digital signal processor of the node B 112A to 112D. Some process steps may be executed, depending on the embodiment, in the digital signal processor of the radio network controller 110A, 110B.

Even though the invention has been disclosed above with reference to an example according to the accompanying drawings, it is clear that the invention is not restricted thereto but can be modified in several ways within the scope of the appended claims.

1. A method of controlling radio resources in a High Speed Uplink Packet Access system, the method including:
communicating data blocks between a user equipment and a network infrastructure over a physical High Speed Uplink Packet Access channel;
communicating block acknowledgement messages between the user equipment and the network infrastructure, each block acknowledgement message indicating whether or not a data block was received successfully; and
controlling a transmission power of the physical High Speed Uplink Packet Access channel on the basis of at least one block acknowledgement message.

2. The method of claim 1, further including:
generating a block reception quality measure from a plurality of block acknowledgement messages, the block reception quality measure characterising a quality of reception of data blocks associated with the block acknowledgement messages;
performing a comparison between the block reception quality measure and a reference value of the block reception quality measure; and
controlling the transmission power of the physical High Speed Uplink Packet Access channel on the basis of the comparison.

3. The method of claim 2, further including:
generating the reference value of the block reception quality measure; and
signalling the reference value of the block reception quality measure.

4. The method of claim 1, further including controlling the transmission power of the physical High Speed Uplink Packet Access channel by accounting for a transport format applied to data blocks to be communicated over the physical High Speed Uplink Packet Access channel.

5. The method of claim 1, further including
generating a block reception quality independent gain factor;
generating a block reception quality dependent gain factor on the basis of the at least one block acknowledgement message; and
controlling the transmission power of the physical High Speed Uplink Packet Access channel by using the block reception quality independent gain factor and the block reception quality dependent gain factor.

6. The method of claim 5, further including signalling the block reception quality independent gain factor.

7. The method of claim 1, further including controlling transmission power of the physical High Speed Uplink Packet Access channel in relation to a transmission power of an uplink physical data channel carrying the physical High Speed Uplink Packet Access channel.

8. A user equipment supporting a High Speed Uplink Packet Access protocol, including:
a transmitter for communicating data blocks between the user equipment and a network infrastructure over a physical High Speed Uplink Packet Access channel;
a receiver for communicating block acknowledgement messages between the user equipment and the network infrastructure, each block acknowledgement message indicating whether or not a data block was received successfully; and
a High Speed Uplink Packet Access channel power controller for controlling a transmission power of the physical High Speed Uplink Packet Access channel on the basis of at least one block acknowledgement message.

9. The user equipment of claim 8, wherein the High Speed Uplink Packet Access channel power controller is configured to generate a block reception quality measure from the plurality of block acknowledgement messages, the block reception quality measure characterising a quality of reception of data blocks associated with the block acknowledgement messages,
wherein the High Speed Uplink Packet Access channel power controller is configured to perform a comparison between the block reception quality measure and a reference value of the block reception quality measure, and
wherein the High Speed Uplink Packet Access channel power controller is configured to control the transmission power of the physical High Speed Uplink Packet Access channel on the basis of the comparison.

10. The user equipment of claim 9, further including a reference value receiver for receiving the reference value of the block reception quality measure.

11. The user equipment of claim 8, wherein the High Speed Uplink Packet Access channel power controller is configured to control the transmission power of the physical High Speed Uplink Packet Access channel by taking into account a transport format applied to data blocks to be communicated over the physical High Speed Uplink Packet Access channel.

12. The user equipment of claim 8, wherein the High Speed Uplink Packet Access channel power controller is configured to generate a block reception quality independent gain factor,
wherein the High Speed Uplink Packet Access channel power controller is configured to generate a block reception quality dependent gain factor on the basis of the at least one block acknowledgement message, and
wherein the High Speed Uplink Packet Access channel power controller is configured to control the transmission power of the physical High Speed Uplink Packet Access channel by using the block reception quality independent gain factor and the block reception quality dependent gain factor.

13. The user equipment of claim 8, further including a gain factor receiver for receiving a block reception quality independent gain factor,
wherein the High Speed Uplink Packet Access channel power controller is configured to generate a block reception quality dependent gain factor on the basis of the at least one block acknowledgement message, and
wherein the High Speed Uplink Packet Access channel power controller is configured to control the transmission power of the physical High Speed Uplink Packet Access channel by using the block reception quality independent gain factor and the block reception quality dependent gain factor.

14. The user equipment of claim 8, wherein the High Speed Uplink Packet Access channel power controller is configured to control transmission power of the physical High Speed Uplink Packet Access channel in relation to a transmission power of an uplink physical data channel carrying the physical High Speed Uplink Packet Access channel.

15. A User equipment supporting a High Speed Uplink Packet Access protocol, including:
a first communicating means for communicating data blocks between the user equipment and a network infrastructure over a physical High Speed Uplink Packet Access channel;
a second communicating means for communicating block acknowledgement messages, each block acknowledgement message indicating whether or not a data block was received successfully; and
a controlling means for controlling transmission power of the physical High Speed Uplink Packet Access channel on the basis of at least one block acknowledgement message.

16. A wireless telecommunications system supporting a High Speed Uplink Packet Access protocol, the wireless telecommunications system including a network infrastructure and a user equipment comprising:
a transmitter for communicating data blocks between the user equipment and the network infrastructure over a physical High Speed Uplink Packet Access channel;
a receiver for communicating block acknowledgement messages between the user equipment and a network infrastructure, each block acknowledgement message indicating whether or not a data block was received successfully; and
a High Speed Uplink Packet Access channel power controller for controlling a transmission power of the physical High Speed Uplink Packet Access channel on the basis of at least one block acknowledgement message.

17. The wireless telecommunications system of claim 16, wherein the High Speed Uplink Packet Access channel power controller is configured to generate a block reception quality measure from a plurality of block acknowledgement messages, the block reception quality measure characterising a quality of reception of data blocks associated with the block acknowledgement messages,
wherein the High Speed Uplink Packet Access channel power controller is configured to perform a comparison between the block reception quality measure and a reference value of the block reception quality measure, and
wherein the High Speed Uplink Packet Access channel power controller is configured to control the transmission power of the physical High Speed Uplink Packet Access channel on the basis of the comparison.

18. The wireless telecommunications system of claim 17, wherein the network infrastructure comprises:
a reference value generator for generating the reference value of the block reception quality measure; and
a reference value transmitter for signalling the reference value of the block reception quality measure, and
wherein the user equipment further comprises a reference value receiver for receiving the reference value of the block reception quality measure.

19. The wireless telecommunications system of claim 16, wherein the network infrastructure comprises:
a gain factor generator for generating a block reception quality independent gain factor; and
a gain factor transmitter for signalling the block reception quality independent gain factor,
wherein the user equipment further comprises:
a gain factor receiver for receiving the block reception quality independent gain factor,
wherein the High Speed Uplink Packet Access channel power controller is configured to generate a block reception quality dependent gain factor on the basis of the at least one block acknowledgement message, and
wherein the High Speed Uplink Packet Access channel power controller is configured to control the transmission power of the physical High Speed Uplink Packet Access channel by using the block reception quality independent gain factor and the block reception quality dependent gain factor.

20. A wireless telecommunications system supporting a High Speed Uplink Packet Access protocol, the wireless telecommunications system comprising:
a first communicating means for communicating data blocks between a user equipment and a network infrastructure over a physical High Speed Uplink Packet Access channel;
a second communicating means for communicating block acknowledgement messages between the user equipment and the network infrastructure, each block acknowledgement message indicating whether or not a data block was received successfully; and
controlling means for controlling a transmission power of the physical High Speed Uplink Packet Access channel on the basis of at least one block acknowledgement message.

21. A network element of a wireless telecommunications system supporting a High Speed Uplink Packet Access protocol, the network element comprising generating means for generating a reference value of a block reception quality measure, the reference value providing a value that is compared with a block reception quality measure generated from a plurality of the block acknowledgement messages in a user equipment, the block reception quality measure characterising the quality of reception of data blocks carried by a physical High Speed Uplink Packet Access channel, a transmission power of the physical High Speed Uplink Packet Access channel being controlled on the basis of a comparison between the reference value and the block reception quality measure, wherein
the generating means is configured to signal the reference value of the block reception quality measure to the user equipment.

22. A computer program embodied in a computer readable medium for executing a computer process for controlling radio resources in a High Speed Uplink Packet Access system, the process including:
communicating data blocks between a user equipment and a network infrastructure over a physical High Speed Uplink Packet Access channel;
communicating block acknowledgement messages between the user equipment and the network infrastructure, each block acknowledgement message indicating whether or not a data block was received successfully; and
controlling a transmission power of the physical High Speed Uplink Packet Access channel on the basis of at least one block acknowledgement message.

23. A computer program distribution medium readable by a computer and encoding a computer program of instructions for executing a computer process for controlling radio resources in a High Speed Uplink Packet Access system, the process including:
communicating data blocks between a user equipment and a network infrastructure over a physical High Speed Uplink Packet Access channel;
communicating block acknowledgement messages between the user equipment and the network infrastructure, each block acknowledgement message indicating whether or not a data block was received successfully; and
controlling transmission power of the physical High Speed Uplink Packet Access channel on the basis of at least one block acknowledgement message.

24. The computer program distribution medium of claim 23, the distribution medium comprising a computer readable medium, a program storage medium, a record medium, a computer readable memory, a computer readable software distribution package, a computer readable signal, a computer readable telecommunications signal, and a computer readable compressed software package.
